(19) United States
(12) Patent Application Publication
(10) Pub. No.: US 2002/0085716 A1
(43) Pub. Date: Jul. 4, 2002

(54) Encryption during modulation of signals

(76) Inventor: Barbir Abdulkader, Nepean (CA)

Correspondence Address: Gowling Lafleur Henderson LLP, Suite 2600, 160 Elgin Street, Otawa, ON, K1P 1C3, CA

(21) Appl. No.: 10/014,535

(22) Filed: Dec. 14, 2001

(30) Foreign Application Priority Data
Dec. 29, 2000 (CA) 2,329,889

(51) Int. Cl. H04N 7/167

(52) U.S. Cl. 380/205

(57) ABSTRACT

The invention allows the introduction in real-time of at least sufficient security to minimize the risk of intruders overhearing data on a particular link. This reduces the risk of being victim to either a Type 1—Unauthorized access threat or a Type 3—Message sequencing threat. The method involves encryption at the physical data link level where the form of the encryption affects groups of data bits. The effect of introducing the invention is to add noise to the signal in such a way that it can be subtracted from the received signal leaving only the original signal. The resulting signal, were it to be observed by a person other than the intended recipient, would have an effective Signal to Noise (S/N) ratio of less than 1. The masking effect of this added ‘noise’ signal hides the original signal from any eavesdroppers, since it well-known in the art that for a non-periodic signal to be effectively recovered it must have a S/N greater than 1.

### FIELD OF THE INVENTION

The invention relates to the field of data communications, specifically in the area of data security.

### BACKGROUND OF THE INVENTION

Typically, security of telecommunications links must deal with a number of different potential risks. These are described briefly below:

Type 1—Unauthorized access threat

Access control refers to the process of identifying legitimate access request and enables information exchange between local and authorized remote entities. Unauthorized access threat refers to the action that unauthorized entity can send fake or illegitimate messages in order to disturb the normal operation or to inject false information. Another type of illegal access is that an illegitimate entity sends a request for information it is not authorized to acquire.

Type 2—Modification of information threat

Modification of information attack refers to the act of an attacker altering legitimate messages when message authentication is absent. The intruder may alter in-transit legitimate messages generated by an authorized entity in such way that normal operation is jeopardized.

Type 3—Message sequencing threat

The message sequencing threat is the danger that messages may be arbitrarily re-sequenced, delayed, or replayed back such that normal operations are jeopardized. This is known as a ‘playback attack’.

Type 4—Disclosure of information threat

The disclosure threat is the danger that messages are obtained and disclosed to the unintended party. With lack of access control, any unauthorized party can contact and retrieve information or the attacker can eavesdrop on the links to steal the information

Type 5—Denial of service threat

Denial of service threat usually refers to the type of attack that stops or slows the normal operation of a network, link or node by diverting or depleting resources, or by exploiting certain implementation shortfalls (weaknesses).

Various levels of encryption are used for different objectives. In particular encryption/decryption are used to reduce the risk offered by a Type 1—Unauthorized access threat. This can also be used to reduce the risk of a ‘play-back attack’—Type 3—Message sequencing threat.

Current technology does not allow the real-time encryption and decryption of very high data rate systems, even with significant hardware support. Typically systems overcome this shortcoming by carrying out encryption either at lower data rates before the data requiring encryption has been multiplexed onto a high speed facility, or by encrypting the whole of the data in advance of multiplexing and transmission.

What is needed is a technique to introduce some degree of encryption in real-time to reduce the risks of unauthorised access without the need for fundamental changes to the implementing technology.

### SUMMARY OF THE INVENTION

The invention described here allows the introduction in real-time of at least sufficient security to minimize the risk of intruders overhearing data on a particular link, thereby reducing the risk of being victim to either a Type 1—Unauthorized access threat or a Type 3—Message sequencing threat—a so-called ‘play-back attack’.

According for the invention, there is provided an encryption system comprising: a transmitting device for modulating data with a pseudo-random signal for signalling over a transmission medium; and a receiving device for receiving said data by removing said pseudo-random signal.

According to the invention, there is further provided a method of encrypting data comprising the steps of modulating data with a pseudo-random signal for signalling over a transmission medium; transmitting said data; receiving said data; and removing said pseudo-random signal.

Other advantages, objects and features of the present invention will be readily apparent to those skilled in the art from a review of the following detailed description of preferred embodiments in conjunction with the accompanying drawings and claims

### BRIEF DESCRIPTION OF THE DRAWINGS

The embodiments of the invention will now be described with references to the accompanying drawings, in which

FIG. 1 shows the general arrangement of major components in a transmission system where the invention might be practiced;

FIG. 2, shows the effect of adding a ‘noise’ signal to the input signal is illustrated;

FIGS. 3 and 4 can be compared to show the effect of a ‘noise’ signal on the spectrum of input signal; and

FIG. 5 depicts one embodiment of the invention using laser technology as an example

### DETAILED DESCRIPTION OF THE INVENTION

The approach used is to consider encryption at the physical data link level, and to use some form of encryption that affects groups of data bits. Further, the general approach taken is to add noise to the signal in such a way that it can be subtracted from the received signal leaving only the original signal, possibly modified by imperfect transmission—i.e., actual noise. The signal, were it to be observed by a person other than the intended recipient, would have an effective Signal to Noise (S/N) ratio of less than 1. The masking effect of this added ‘noise’ signal is to hide the original signal from any eavesdroppers, since it well-known in the art that for a non-periodic signal to be effectively recovered it must have a S/N greater than 1.

This technique reduces the computation effort to encrypt the data. hi essence this is encryption of the data stream, rather than the data itself, although the effect is the same in that the security is inherently that of the encryption technology, rather than being dependent on the data.

Although the technique is valid for any modulation technology, it is most valuable at the higher speeds. The invention particularly lends itself to fibre-optic-based transmission technology, and is applicable to other types of transmission technology. For convenience, in the following descriptions we use examples based on a fibre-optics system.

Put simply, the method proposed is to modulate the source signal with a waveform whose characteristics are defined by parameters derived from the output of a Random Number Generator seeded by a secret key. Using Public Key Infrastructure (PKI) or other techniques to ensure security in transferring the key, the receiver can use the same sequence to demodulate the data.

In summary a technique is described/disclosed which permits encryption in real time even when implemented in very high speed transmission systems. The technique is equally applicable in low-bandwidth systems where its main attribute is the lower computing power required to encrypt data compared to the case of encrypting the data itself.

Other aspects of the invention will be clear to those skilled in the art on examination of the figures and description following.

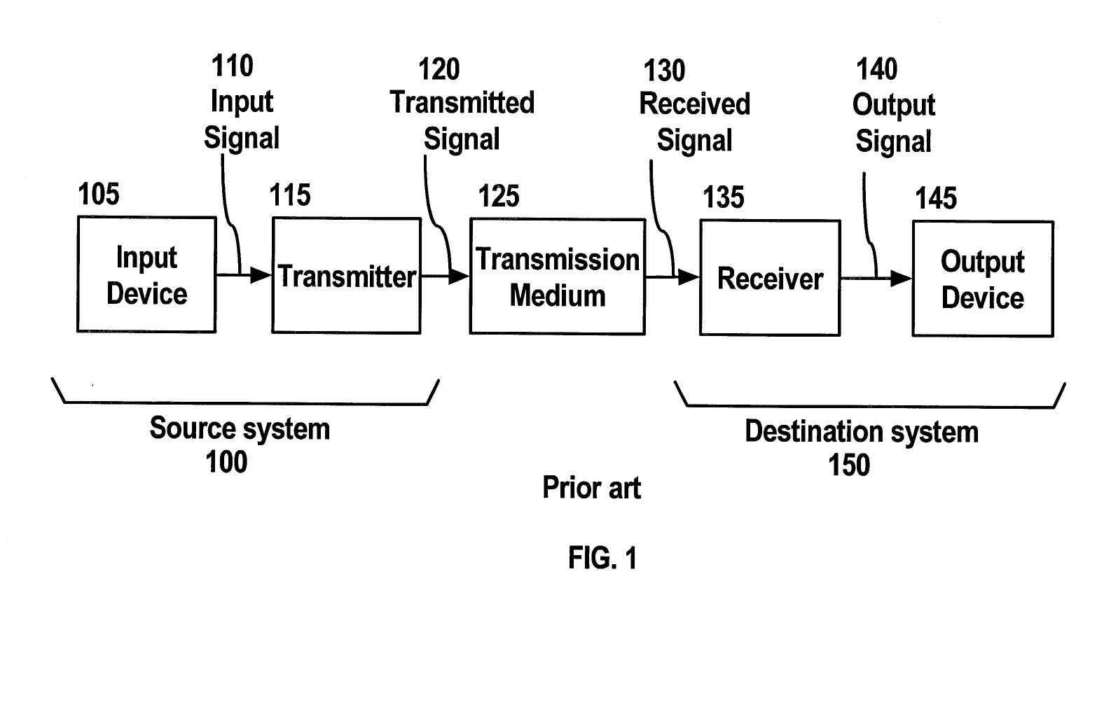

In a transmission system as shown in FIG. 1, at the source system 100 an input signal g(t) 110 is passed from some input device 105 to the transmitter 115 where it is modulated onto some form of carrier resulting in the function s(t) 120. After passing over the transmission medium 125 the received signal r(t) 130 is passed to the destination system 150 where a receiver 135 demodulates it to produce the output signal \check{g}(t) 140 which is in turn passed to some output device 145. In a perfect system, g(t)=\check{g}(t).

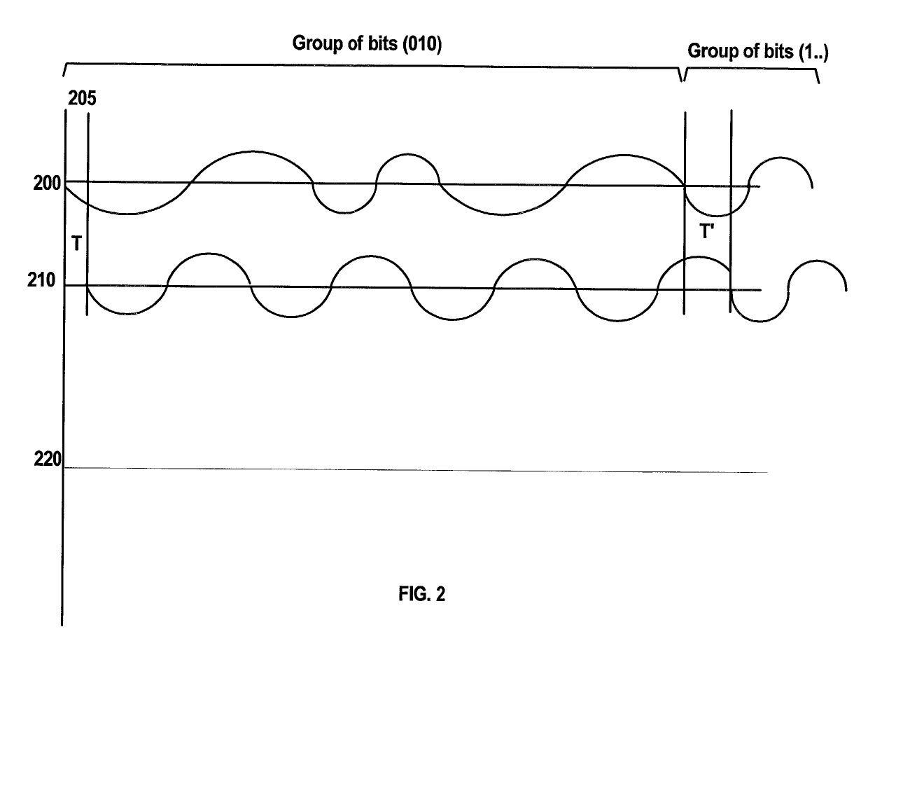

FIG. 2 shows part of an analogue data signal 200 which can be assumed to be modulated with a ‘group of bits’ from the data to be transmitted. The size of the group of bits in this example is three, and one full group is shown with the start of a second group. The modulation technique for this example is Frequency Shift Keying, and the bits in the first group are 010 A second signal 210, known as a pseudo-random ‘noise’ or masking signal, is defined by the following attributes: initial phase shifted with respect to the data signal 200 by an amount T 205, frequency F, amplitude A. The two signals 200 and 210 are additively combined to produce a third modulated signal 220.

The three attributes or variables T, F and A are sufficient to fully characterize the second signal so that if the three are also known to the receiver, they can be used to create a second signal with inverted polarity (i.e., with opposite amplitude). By adding this recreated inverted signal to an incoming signal in a demodulation process, similar to modulation process described above, it is possible to remove the effect of the masking signal.

In this very simple and brief example the start of the second group of bits is shown having a different initial phase shift T′ for the masking signal.

In a further embodiment, the values of these attributes are only defined for the period required to transmit a ‘group of bits’. They are then modified for each succeeding ‘group of bits’. The resulting transmitted signal is thus very difficult to interpret unless the same Random Number Generator is used, seeded with the same key, thereby allowing accurate recovery of all three parameters.

Any secure method may be used to convey from the transmitter to the receiver the Random Number Generator function and the key to seed it, although the means are outside the scope of this invention.

Frequency Domain

The technique may also conveniently be described with reference to the ‘frequency domain’. In this case, the original signal may be seen as being composed of a Fourier series: the fundamental frequency ƒ plus harmonics 2ƒ, 3ƒ, 4ƒ, . . .

The imposition of a second ‘noise’ signal on the connection has two effects. It introduces a second fundamental frequency—that of the second signal—and its related harmonics. The other effect is to somewhat ‘broaden’ the spectrum of each component because of the effective phase, frequency and amplitude variations which affect each component.

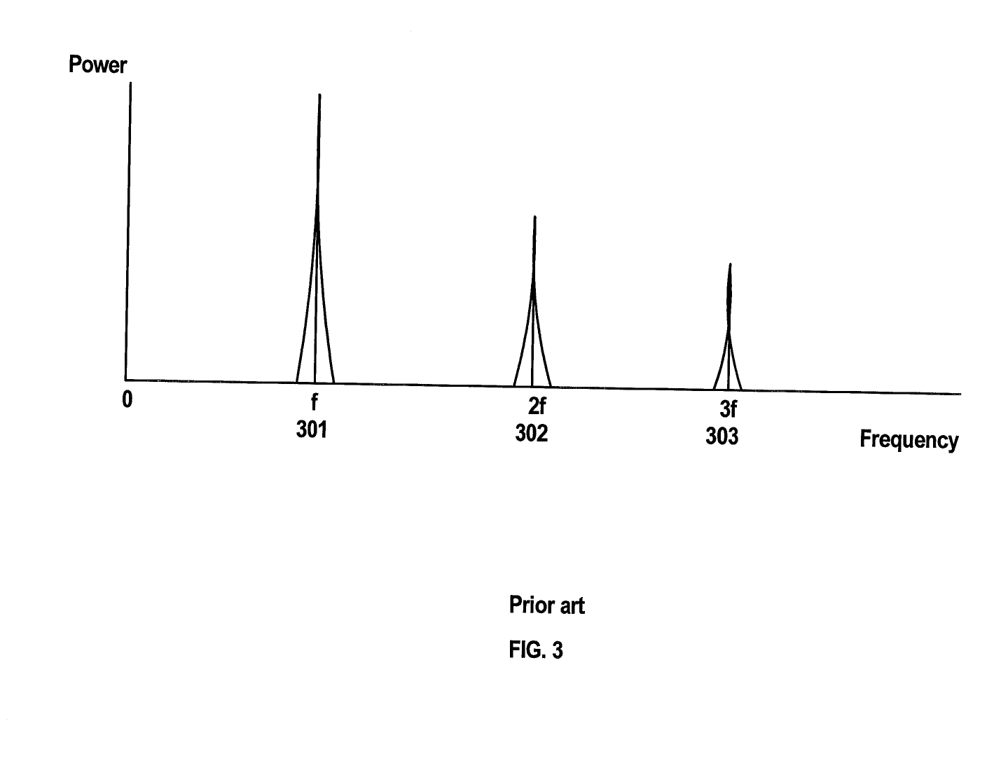

In FIG. 3 the various spectral components of a sample of the un-encrypted original signal transmitting a ‘group of bits’ are shown graphically as the fundamental frequency 301, and two harmonics 302 and 303. There is no protection against detection of the fundamental frequency and its related components to recreate the original waveform.

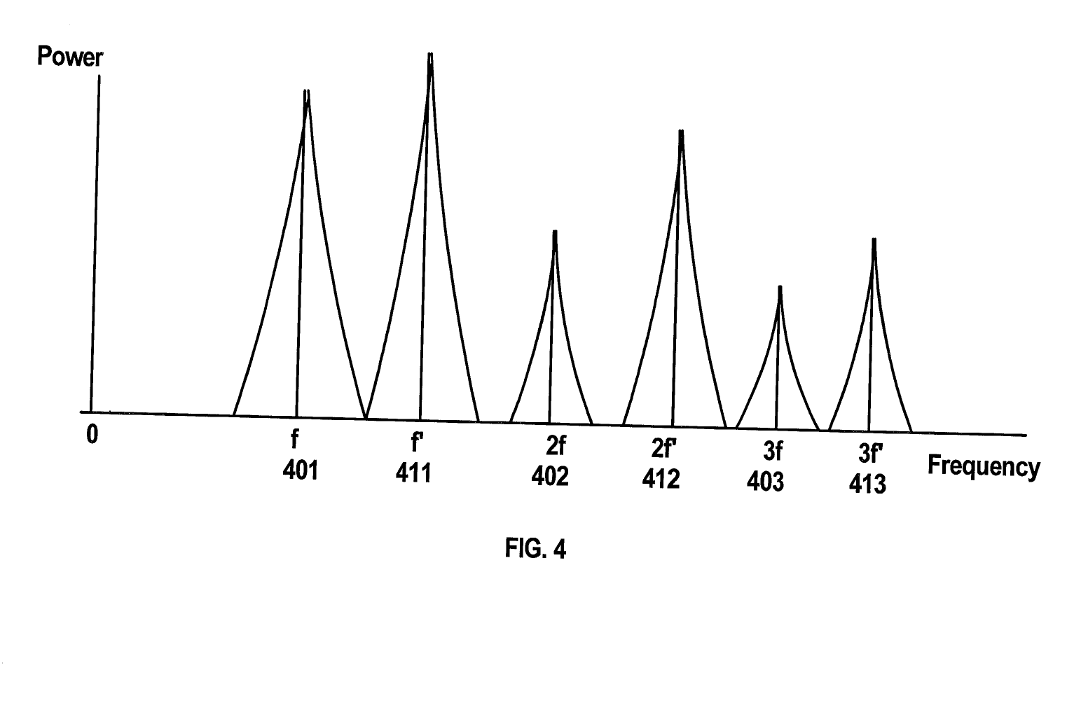

On the other hand, in FIG. 4 the spectrum is shown that results from adding a ‘noise’ signal to the original signal. Here there are two sets of components: the fundamental frequency of the wanted signal 401, and two of its harmonics 402 and 403; and the fundamental frequency of the ‘noise’ signal 411, and two of its harmonics 412 and 413. In this case, any intruder attempting to examine this spectrum to determine which components were of interest would have problems. Given time, it might be possible to determine the useful components. However, the technique includes the changing of parameters of the ‘noise’ signal at frequent intervals, viz., after every ‘group of bits’ so that insufficient samples would be available to mount an effective attack against this form of encryption. In a further embodiment of the invention the number of bits in the ‘group of bits’ is itself a variable, further decreasing the chance of an intruder finding the valid parameters before they are changed again.

Although for some short duration the ‘noise’ signal is a likely a pure sinusoid, the variation of the ‘noise’ signal with time, based on changing its parameters at the start of each group of bits, means that it will appear in an integrated spectrum as random noise.

Example system

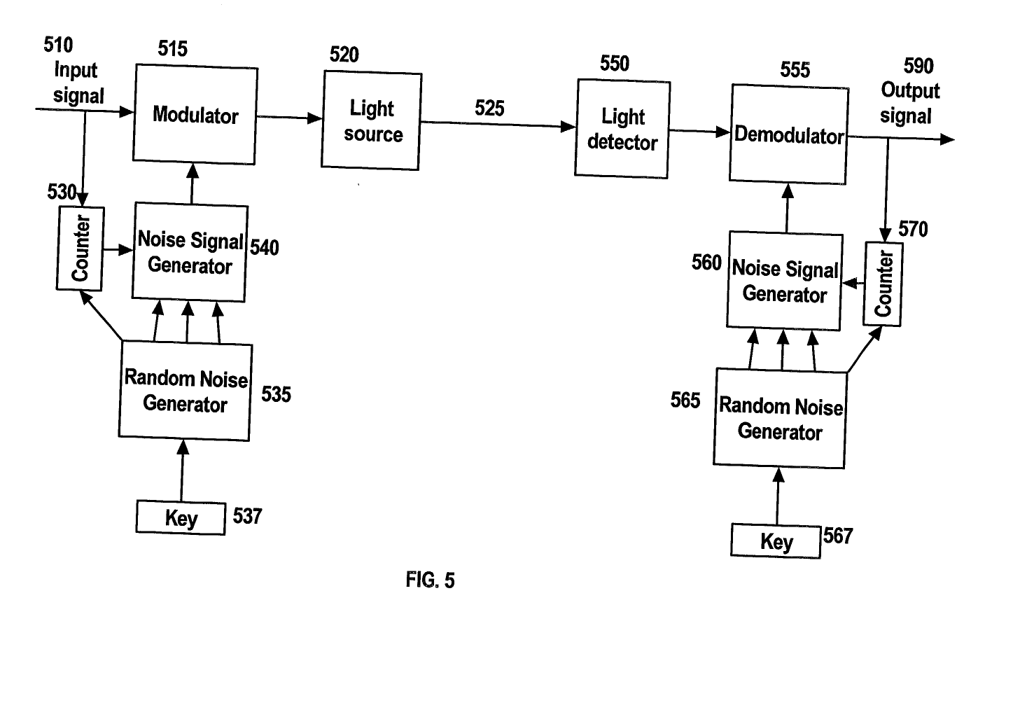

An exemplary optical-fibre-based system is shown in FIG. 5. The input signal 510 is first passed to one input of a modulator 515 the output of which is applied to a light source 520 (e.g. a laser diode) for transmission over an optical fibre 525. The input signal 510 is also fed to a counter 530 which keeps track of the number of bits in a group of bits, according to one of the outputs of a Random Number Generator 535 seeded with a secret key 537. This counter triggers a change in the properties of a modulating ‘noise’ signal by causing the ‘noise’ signal generator 540 to read new parameters from other outputs of the Random Number Generator 535. The resultant modulating ‘noise’ signal is fed to the other input of the modulator 515.

At the receiving subsystem, a light detector 550 translates the optical signal from the fibre 525 to an electrical signal which is passed to one input of a demodulator 555, the output of which is the output signal 590. The ‘noise’ signal used to demodulate the incoming signal is generated by a further ‘noise’ signal generator 560 according to parameters from a further Random Number Generator 565, seeded with a key 567 having the same value as the key 537 for Random Number Generator 535 of the transmitting subsystem. Synchronisation of the number of bits in a ‘group of bits’ is maintained by feeding the output of the demodulator into a further counter 570 which keeps track of the number of bits as conveyed to it by one of the outputs of the Random Number Generator 535. This counter then triggers a change in the properties of the demodulating ‘noise’ signal by causing the ‘noise’ signal generator 560 to read new parameters from other outputs of the Random Number Generator 565.

It is important that the transmitting subsystem and receiving subsystem use compatible Random Number Generators and keys, and that they achieve and maintain synchronisation with respect to start of each of the ‘groups of bits’ being conveyed. One method of achieving initial synchronisation is now described. The transmission begins with no modulation (or encryption) of the data. A known unique combination or sequence of data bits is transmitted and on completion the Random Number Generator seeded with the key and the next ‘group of bits’ is encrypted according to the parameters issued as normal. Similarly, at the receiving subsystem, detection of this unique sequence causes that Random Number Generator to be seeded with the same key and it can then decrypt the data according to the parameters issued as normal. Thereafter, synchronisation is maintained as described above. Other methods may equally be used to achieve the same ends.

Cascading

In a fibre-optic system, or any other system where the functions of modulation of an intermediate signal by the input data and the further modulation of the transmitted carrier by that intermediate signal occurs, the technique may be applied separately to both modulation steps, each with separate Random Number Generator and seed key.

Signal to Noise Ratio

For any non-periodic signal, successful detection depends on distinguishing that signal from any unwanted interfering signal. In general terms, the ratio of the wanted signal (S) to the unwanted signal noise (N) should be greater than 1 for reliable detection of the wanted signal (S). Shannon's Law sets criteria which relate error rate to the signal-to-noise ratio (S/N). Further, a relationship derived from this is that the error rate for a given signal increases with decreasing S/N. Intuitively, it can be argued that, if the amount of noise were to double, then the number of errors would tend to increase if the data rate and signal strength were to remain constant. (pp57-59).

Parameter selection.

The selection of the ranges of the various parameters which define the ‘noise’ signal, and the number of bits in a ‘group of bits’, is not critical although the overall effectiveness of the technique can be reduced by selection of inappropriate values.

Similarly, the number of discrete values within the range of these parameters is not critical, although again, inappropriate choices may reduce the overall effectiveness.

During operation, the values actually used are derived by any suitable means from the output of the Random Number Generator. For example, four successive outputs might be used, with an appropriate modulus function to produce numbers in the ranges required.

Numerous modifications, variations and adaptations may be made to the particular embodiments of the invention described above without departing from the scope of the invention, which is defined in the claims.

What is claimed is:

1. An encryption system comprising:
a transmitting device for modulating data with a pseudo-random signal for signalling over a transmission medium; and
a receiving device for receiving said data by removing said pseudo-random signal.

2. The system of claim 1 wherein said transmitting device further comprises:
means to generate a second modulated signal;
means to add said second modulated signal to said data signal to produce a transmitted signal; and
means to send said transmitted signal over a transmission medium.

3. The system of claim 2 wherein said receiving device further comprises:
means to generate a third modulated signal;
means to subtract said third modulated signal from said transmitted signal to produce a data output signal; and
means to demodulate said output signal to produce a second data output signal.

4. The system of claim 3 wherein said second modulated signal and said third modulated signal are pseudo-random and opposite in amplitude, but otherwise identical in phase and frequency, thereby simplifying the demodulation of said data.

5. The system of claim 4 wherein the parameters defining the phase, amplitude and frequency of said second modulated signal and said third modulated signal are derived from a random number generator seeded with a key, thereby increasing the difficulty of an intruder planning to intercept said transmitted signal.

6. The system of claim 5 wherein said random number generator is implemented at both the transmitter and receiver and seeded with the same key so that parameters derived from both are the same and when applied to said means for generating said second modulated signal and said means for generating said third modulated signal result in the same signal being generated, thereby ensuring correct reception of said transmitted signal.

7. The system of claim 6 wherein the data is manipulated as a ‘group of bits’ and the number of bits in a ‘group of bits’ is a parameter and may be varied for each ‘group of bits’.

8. The system of claim 7 wherein said number of bits parameter is derived from a second random number generator.

9. The system of claim 7 wherein said number of bits parameter is derived from the same random number generator as used for the parameters defining said second modulated signal and said third modulated signal.

10. A method of encrypting data comprising the steps of:
modulating data with a pseudo-random signal for signalling over a transmission medium;
transmitting said data;
receiving said data; and
removing said pseudo-random signal.
